(19) United States
(12) Patent Application Publication
(10) Pub. No.: US 2014/0097120 A1
(43) Pub. Date: Apr. 10, 2014

(54) COFFEE POD HOLDER AND TRAY WITH MOVABLE DIVIDERS

(71) Applicant: PRO-MART INDUSTRIES, INC., Irvine, CA (US)

(72) Inventor: Azad Sabounjian, Irvine, CA (US)

(73) Assignee: PRO-MART INDUSTRIES, INC., Irvine, CA (US)

(21) Appl. No.: 13/794,456

(22) Filed: Mar. 11, 2013

Related U.S. Application Data
(60) Provisional application No. 61/709,853, filed on Oct. 4, 2012.

(51) Int. Cl. A47J 31/44

(52) U.S. Cl. CPC A47J 31/44
USPC 206/565

(57) ABSTRACT

A coffee pod tray is provided with a plurality of dividers that may be held by a support frame in a first position to form rows for aligning coffee pods of a first size. The dividers are held by the support in a second position to form rows for aligning coffee pods of a second size.

### CROSS-REFERENCE TO RELATED APPLICATIONS

The Application claims the benefit under 35 U.S.C. 119(e) to Provisional Patent Application No. 61/709,853 filed Oct. 4, 2012, the entire contents of which are incorporated herein by reference.

### BACKGROUND

Rectangular trays with open tops are made to hold several rows of coffee pods. The trays may be slid in and out of a protective housing through an opening in the front of the housing into and out of which the tray is slid. The top of the housing is usually covered by a solid structure to support a coffee making machine in which the coffee pods are used. The trays have dividers which separate rows of coffee pods that sit on the bottom of the tray so the contents of the coffee pod are on the top, readily viewable by a user.

Coffee pods suitable for use in Keurig coffee making machines are currently of several general types as shown in FIGS. 8-10, with these and other pods shown in U.S. Pat. Nos. D452,433, D474,110, D502,362, D647,399, D647,398 and D637,484. The coffee pods comprise a thin plastic cup 1 having a continuous sidewall 2 and an outwardly extending flange 3 at the opening of the cup. The cup 1 can have various shapes but the shapes are typically tapered, being smaller at the bottom and larger at the top. Sometimes the walls of the cups 1 are stepped to form strengthening ribs 4 encircling the cup, especially near the flange 3. Sometimes longitudinal stiffening ribs 5 are used. Many coffee pods are symmetric about a longitudinal axis L. Some coffee pods have an outwardly extending projection 6 formed by the side of the container and shaped to form a pouring spout, with the flange 3 extending around the entire periphery of the top, including the spout. These coffee pots are symmetric about a plane through the middle of the spout and the longitudinal axis L. A foil sheet 7 is fastened to the flange 3, with a tab of foil or the foil itself usually extending outward from the flange a distance sufficient so that a user may grab the tab. In use, coffee is placed in the cups 1 and sealed by the foil to form a coffee pod. The contents are printed on the foil 7 covering the top of the cups 1. The pods are placed in holders having various shapes, including trays having rows separated by dividers, with the pods placed in the rows according to the printed indicia on the foil lids 7, which indicia usually identifies the type of coffee. A user selects a preferred type of coffee based on the printed indicia on the lid 7, removes the pod, pulls the tab to remove the foil and uses the coffee in the pod with a coffee brewing machine to make coffee.

The trays holding the coffee pods have the dividers spaced apart to hold coffee pods of a predetermined size. Some of the coffee pods are not cylindrical but have spouts or protuberances on them. But such coffee pods have a majority of the periphery with a generally circular cross-sectional diameter D, which typically increases toward the top flange 3 and is smallest at the bottom. The dividers forming the rows for the coffee pods are usually spaced apart to accommodate the largest diameter D. If the dividers are spaced a smaller distance apart than the diameter D measured at the top of the divider, then the coffee pods don't fit in the dividers and may tip along the length of the divider and rows between the dividers. If the dividers are spaced much further apart than the diameter D measured as the height of the divider, or slightly more (about 5% to 15% greater), then space and materials are wasted. There is thus a need for coffee pod trays with dividers spaced apart a distance that is predetermined to hold the desired type or size of coffee pods.

The coffee pods come in different sizes. But the trays to hold coffee pods are made for only one size of coffee pod. The sizes are different enough that a divider for the smaller coffee pods cannot hold the larger coffee pods. There is thus a need for a tray to hold different sizes of coffee pods. Further, as the coffee pods are removed for use the movement of the tray in and out of the housings sometimes causes the tray to be pulled out of the housing which can dump the coffee pods out of the tray. Sometimes, the tray does not smoothly slide out of the housing and that causes excess force or jiggling of the tray and housing to the frustration of users. Typical coffee pod trays have a larger height than needed, requiring housings that are higher than needed and openings that are larger than needed. There is thus a need for a lower, compact coffee pod tray and housing where the tray slides easily but resists being accidentally pulled entirely out of its housing.

### BRIEF SUMMARY

A coffee pod tray is provided with a plurality of dividers that may be held by a support frame in a first position to form rows for aligning coffee pods of a first size. The dividers are held by the support in a second position to form rows for aligning coffee pods of a second size. The dividers are supported at opposing ends by a support rail having first and second opposing edges. The first edge has a first series of notches located to position the dividers a first distance apart to accommodate coffee pods of a first size or general diameter. The second edge a second series of notches located to position the dividers a second distance apart to accommodate coffee pods of a second size or general diameter which is different than the first size.

There is thus provided a coffee pod holder for a rectangular tray. The holder has a plurality of dividers defining rows for aligning a plurality of first or second coffee pods having first and second sizes which are different. The holder may include a frame having four corner posts at each corner of a rectangle sized to fit within a tray. First and second support rails are removably connected to a different two of the corner posts so the support rails are generally parallel to each other. Each support rail has opposing first and second edges with a first set of notches in the first edge and a second set of notches in the second edge. The first set of notches is different in number than the second set of notches. The first set of notches is located at corresponding first locations along a length of each rail Likewise, the second set of notches is located at corresponding second locations along a length of each rail. The rails have a first position in which both of the first edges are located above the second edges and have a second position in which both of the second edges are located above the first edges. A plurality of dividers extend between the support rails with each divider at a different set of corresponding locations of the first set of notches so the dividers are parallel to each other. The dividers may be sized and configured so each divider extends between two notches each on a different support rail so the dividers are parallel. The dividers advantageously have a cross-sectional shape that fits into one of the first set of notches when the support rails are in the first position so the cross-sectional shape of the divider cooperates with the shape of that notch to restrain lateral motion of the divider along a length of the support rail in which the notch is located. The dividers have opposing sides which are located a distance apart to define rows between the dividers. The rows are sized to receive and align a plurality of first coffee pods in the rows during use.

Advantageously, both support rails may be removed and positioned with the second set of notches orientated in the second position so a plurality of dividers may rest in corresponding notches of the second set of notches to define a different number of rows for holding a plurality of the second coffee pods during use. Further, one or more of the corner posts may have a position stop located a distance from the distal end of the corner post on which the position stop is located. The position stop restrains movement of one of the support rails along the length of the post on which the position stop is located. Advantageously, the position stops are located so the first edge of the two support rails are in substantially the same plane, as are the dividers. Preferably, the support rails have ends with holes therethrough, with each corner post extending into a different one of the holes to removably connect the support rails to the frame. The holes are preferably cylindrical in shape.

Preferably, the four corner posts form legs of two inverted, U-shaped end frames which are generally parallel to each other. Moreover, first and second connecting members may each extend between and connect to different corner posts, each on a different end frames to form a rectangular support. The connecting members may be parallel to each other and connect to their respective corner posts a predetermined distance from the distal end of each corner post to restrain movement of the support rail along a length of the end post. Preferably, the number of notches in the first set is greater than the number of notches in the second set, with five notches preferred for the first set and four notches preferred for the second set. But other numbers of notches and dividers may be used, including two and three, five and six or six and seven notches (and dividers) or more. Preferably, the number of notches in the first and second set differs by one, and less preferably differs by two.

The notches in each set are preferably spaced apart the same predetermined distance which is selected so that when two of the dividers are placed in corresponding notches in the first and second support rails, the adjacent edges of the two dividers are spaced apart a distance about that of the largest diameter of a K-cup coffee pod. Moreover, the second set of notches are each spaced apart the same predetermined distance which is selected so that when two of the dividers are placed in corresponding notches in the first and second support rails, the adjacent edges of the two dividers are spaced apart a distance about that of the largest diameter of a Vue coffee pod. Moreover, the second set of notches are each spaced apart the same predetermined distance which is selected so that when two of the dividers are placed in corresponding notches in the first and second support rails, the adjacent edges of the two dividers are spaced apart a distance about that of the largest diameter of a Vue coffee pod.

The coffee pod holder is configured to be placed in a tray that is larger than the holder with the holder connected to the tray to restrain movement of the holder relative to the tray. The holder is positioned in the tray so that the dividers on opposing sides of the holder are spaced apart from adjacent sides of the tray a distance sufficient to define a row between the sides of the tray and the adjacent dividers with that row sized to hold coffee pods during use. The tray is inserted into an opening of a housing sized to slidably receive the tray. The opening in the housing preferably has the same shape as the tray but slightly larger to allow insertion and removal of the tray, holder and coffee pods. The dividers may have ends configured to form a snap-lock connection with the support rail. The dividers may also have ends curved to hook over each of the support rails and restrain movement of the divider along a length of the divider.

There is also provided a coffee pod holder for a rectangular tray that is slidably inserted into a housing where the holder has dividers defining rows for holding a plurality of coffee pods in the rows having first and second sizes which are different. The holder may include a divider support frame having four corner posts at each corner of a rectangle that is sized to fit within the tray with the divider support frame being fastened to the tray during use. The holder also includes first and second support rails that are generally parallel to each other. Each support rail has opposing first and second edges with a first set of equally spaced notches in the first edge and a second set of equally spaced notches in the second edge. The first set of notches is different in number than the second set of notches. The support rails have a first position in which both of the first edges are above the second edges and have a second position in which both of the second edges are above the first edges. The support rails are removably connected to two of the corner posts in the first and second position. A plurality of dividers extend between notches of the first set of notches so the dividers are parallel to each other, the dividers fitting into one of the first set of notches and cooperating with that notch to limit lateral motion of the divider along a length of the support rail in which the notch is located, the dividers having two opposing sides located a distance apart to define rows between the dividers for receiving a plurality of first coffee pods in the rows during use when the support rails are in the first position, the dividers being parallel to each other and perpendicular to the support rails. Likewise, a plurality of the dividers extend between notches of the second set of notches and are parallel to each other when the support rails are in the second position. The dividers fit into one of the second set of notches and cooperate with that notch to limit lateral motion of the divider along a length of the support rail in which the notch is located. The dividers have two opposing sides located a distance apart to define rows between the dividers for receiving a plurality of second coffee pods in the rows during use when the support rails are in the second position.

The notches are preferably rectangular and longer along the length of the support rail than they are measured along an axis directed toward the opposing edge of the divider. Moreover, a plurality of the corner posts preferably have a position stop located a distance from the distal end of the corner post on which the position stop is located. The position stop limits movement of one of the support rails along the length of the post on which the position stop is located. The four corner posts preferably form legs of two inverted, U-shaped end frames which are generally parallel to each other. Further, first and second connecting members may each extend between and connect to different corner posts each on a different end frames. The connecting members are parallel to each other and connect to each corner post a predetermined distance from the distal end of each corner post to restrain movement of the support rail along a length of the end post.

### BRIEF DESCRIPTION OF THE DRAWINGS

These and other features of the invention will be better understood by referring to the following description and drawings, in which like numbers refer to like parts throughout, and in which:

FIG. 1 is a front perspective view of a single tray, coffee pod holder with an empty tray extended and with five dividers positioned to support a first type of coffee pod;

FIG. 2 is a front perspective view of the coffee pod holder of FIG. 1 with the tray inside the housing;

FIG. 3 is a front plan view of the coffee pod holder of FIG. 2;

FIG. 4 is a left side plan view of the coffee pod holder of FIG. 2, with the opposing side being a minor image thereof;

FIG. 5 is a back plan view of the coffee pod holder of FIG. 2;

FIG. 6 is a top plan view of the coffee pod holder of FIG. 2;

FIG. 7 is a bottom plan view of the coffee pod holder of FIG. 2;

FIG. 8 is a perspective view of a K-cup coffee pod;

FIG. 9 is a perspective view of Vue® (a registered trademark of Keurig Corp.) cup coffee pod; and

FIG. 10 is a perspective view of a further embodiment of a coffee pod;

FIG. 11 is an exploded perspective view of a divider support for the five dividers as shown in FIG. 1;

FIG. 12 is an exploded perspective view of the divider support of FIG. 13 with one divider ready to be attached to the divider support;

FIG. 13 is a perspective view of the divider assembly of FIG. 1 with five dividers;

FIG. 14 is an exploded perspective view of a divider support for the dividers as shown in FIG. 1 configured for four dividers;

FIG. 15 is an exploded perspective view of the divider support of FIG. 14 with one divider ready to be attached to the divider support;

FIG. 16 is an exploded perspective view of a divider support with four dividers;

FIG. 17a is a side view of an alternative shape for the divider of FIG. 1;

FIG. 17b is a cross-sectional view of a divider taken along section 17b-17b of FIG. 17a;

FIG. 18a is a side view of an alternative shape for the divider of FIG. 1; and

FIG. 18b is a cross-sectional view of a divider taken along section 18b-18b of FIG. 18a

### DETAILED DESCRIPTION

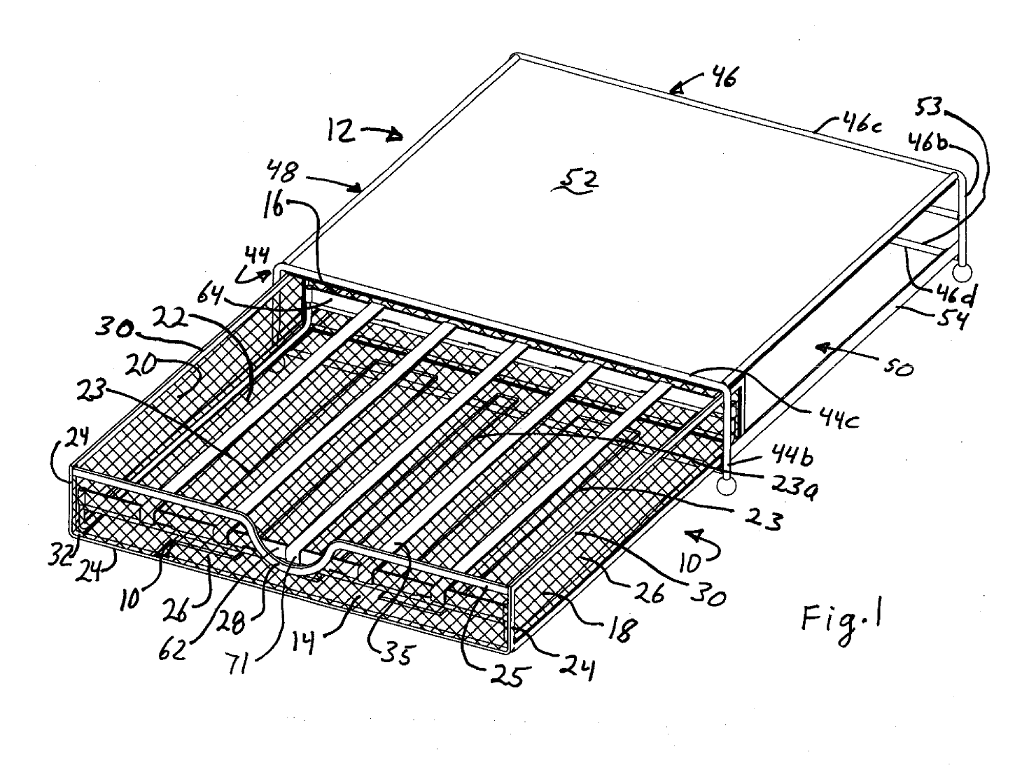

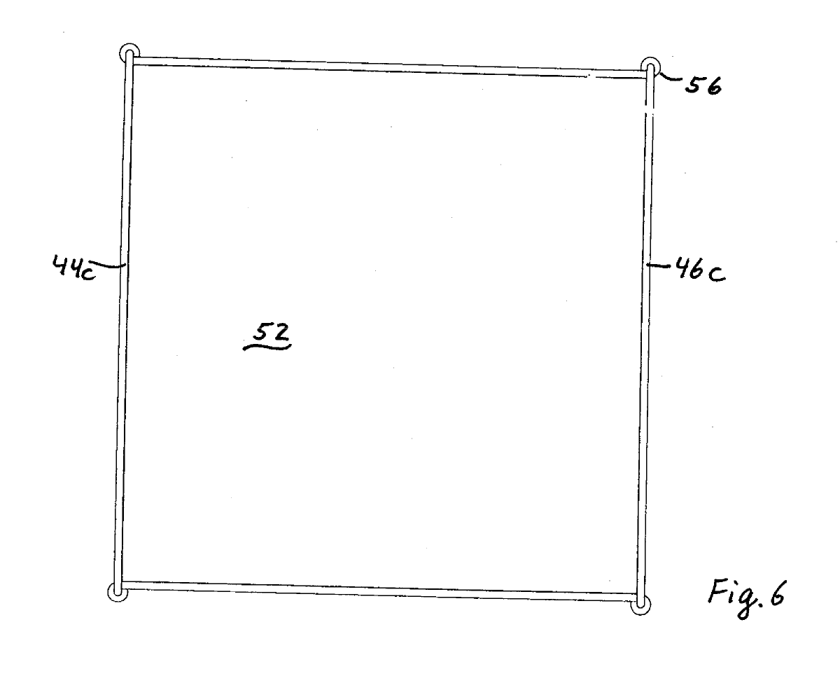

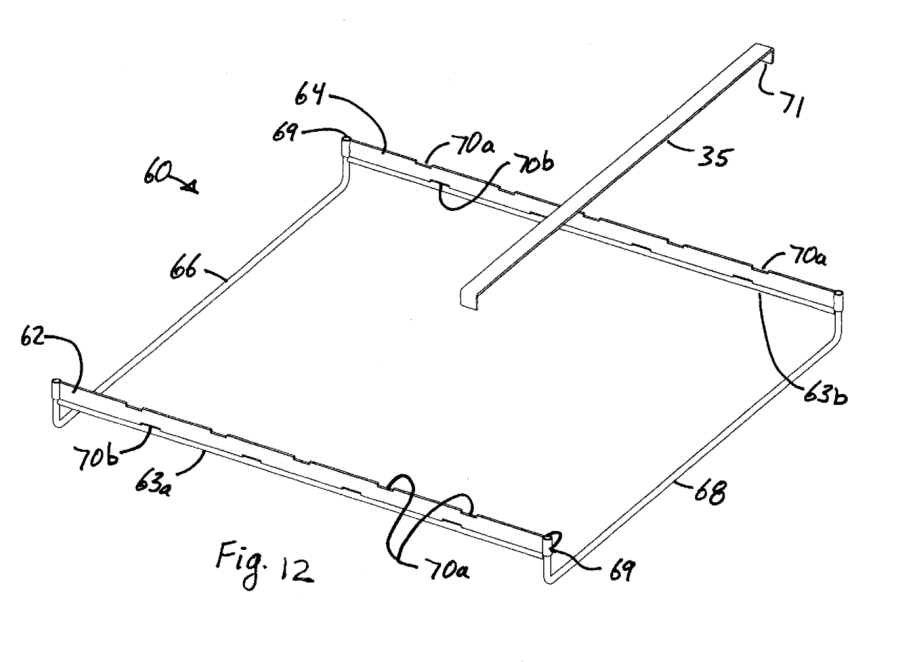

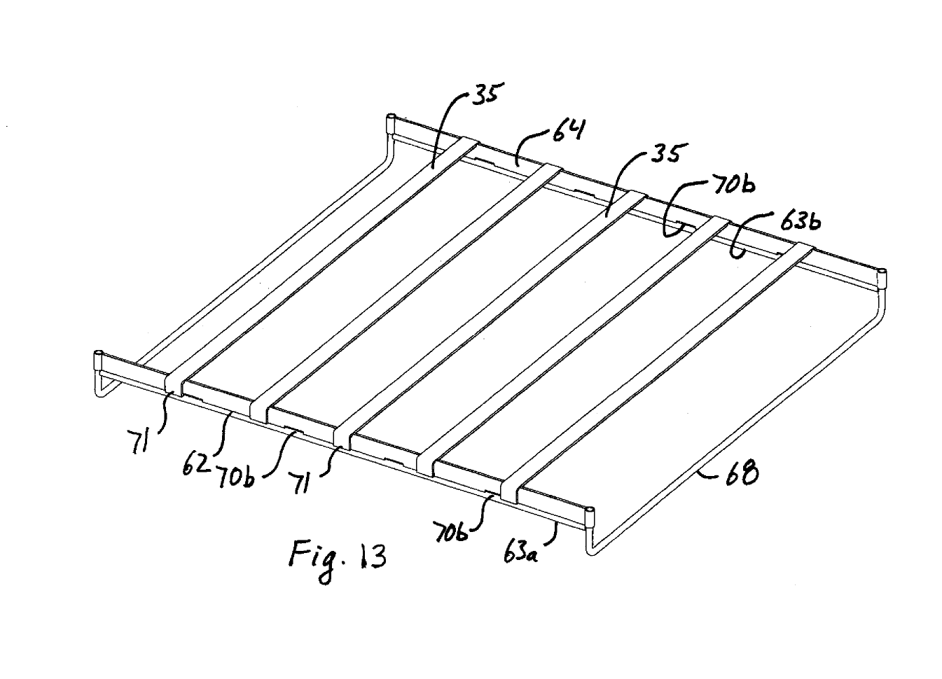

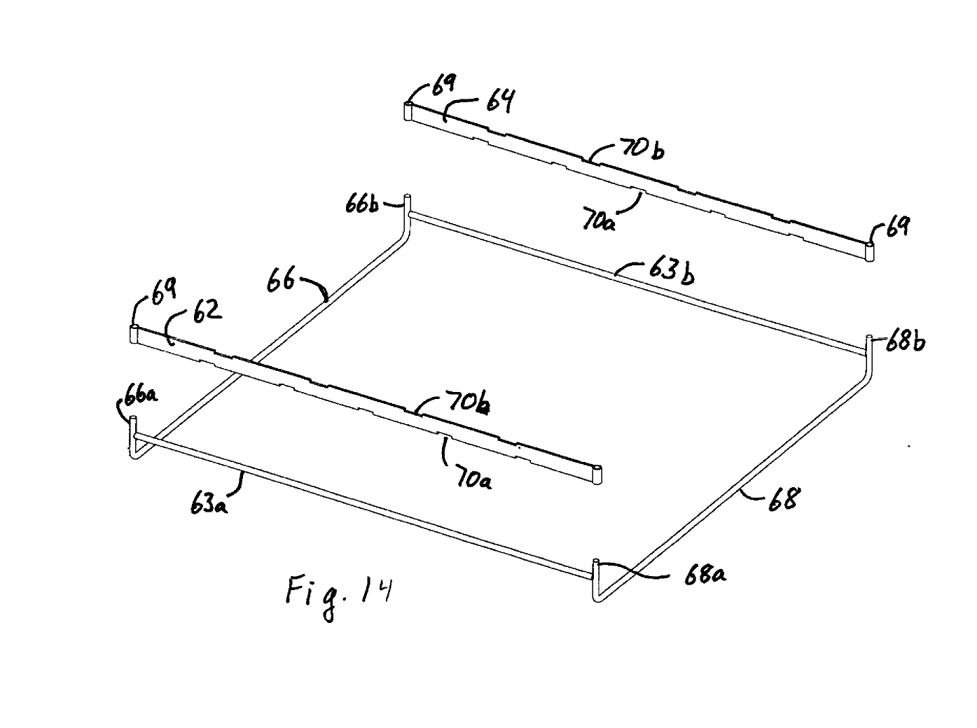

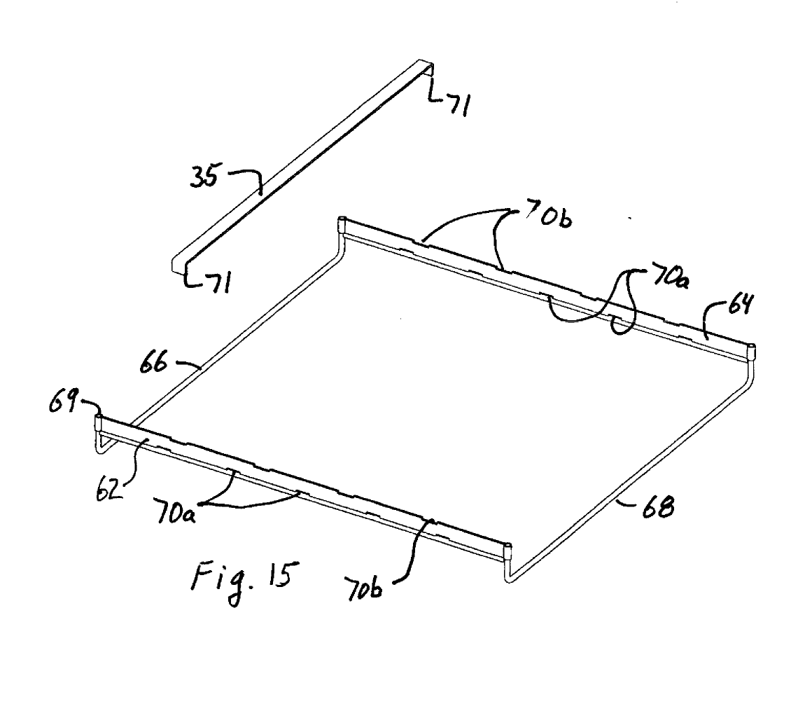

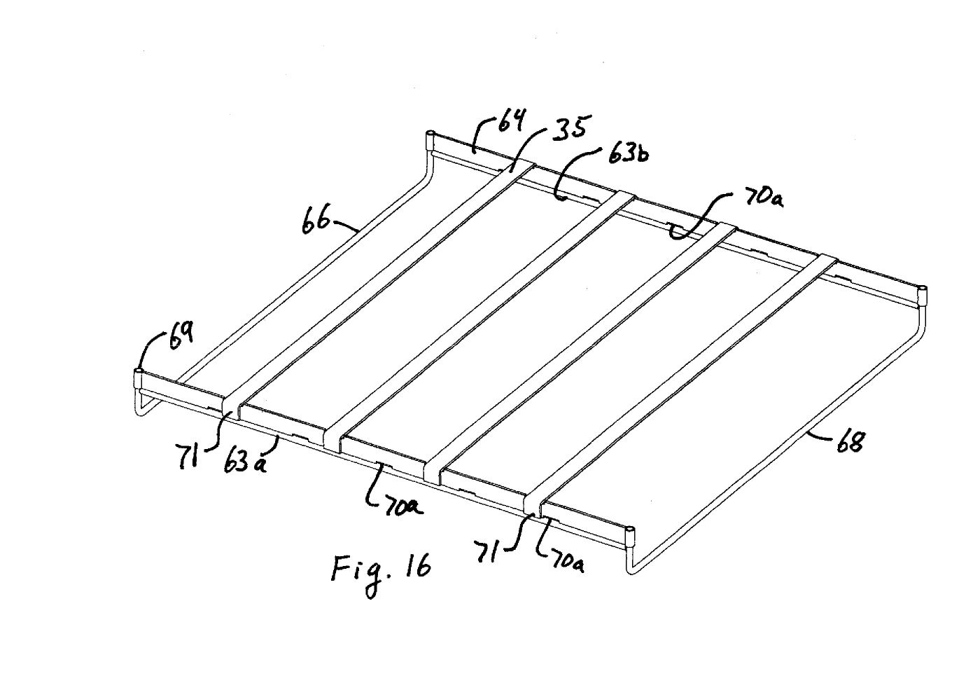

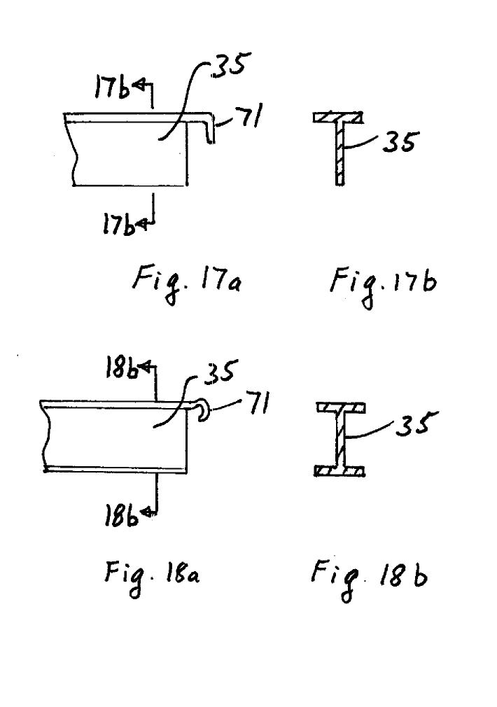

Referring to FIGS. 1-7 and 11-13, a tray 10 is slidably inserted into housing 12. As used herein, the relative directions up and down refer to the directions of the parts shown in FIG. 1, where up or top is vertically upward and down or lower is toward the earth. The side or lateral direction is generally horizontal relative to the orientation of the supporting surface as shown in FIG. 1. Front or forward refers to a direction toward the front of the tray or housing, in the orientation depicted in FIG. 1, while back or rearward refers to the opposite direction.

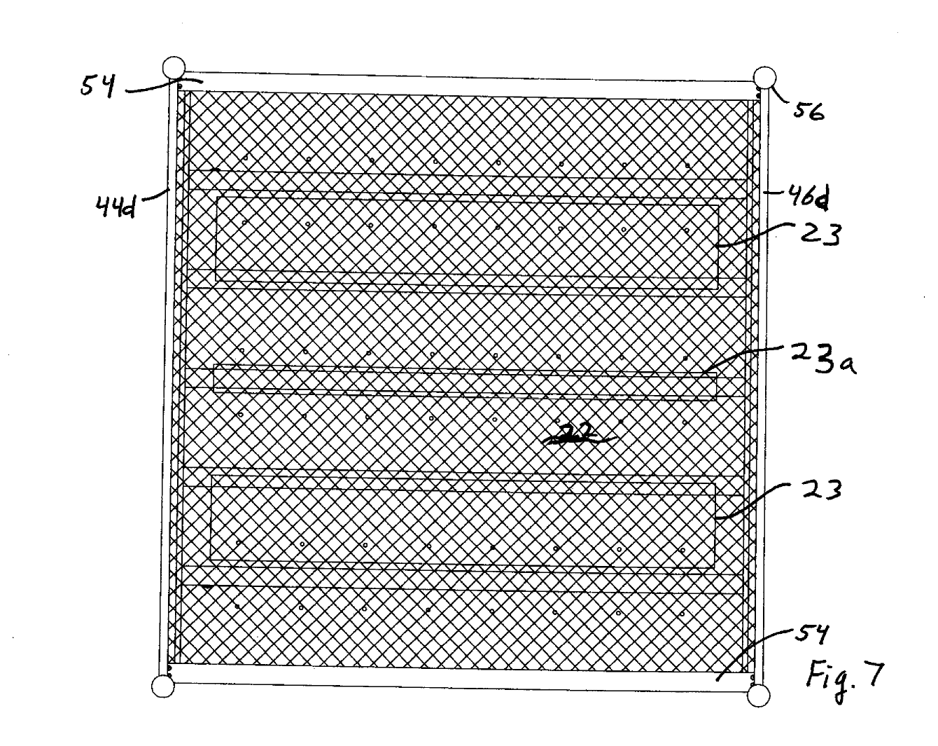

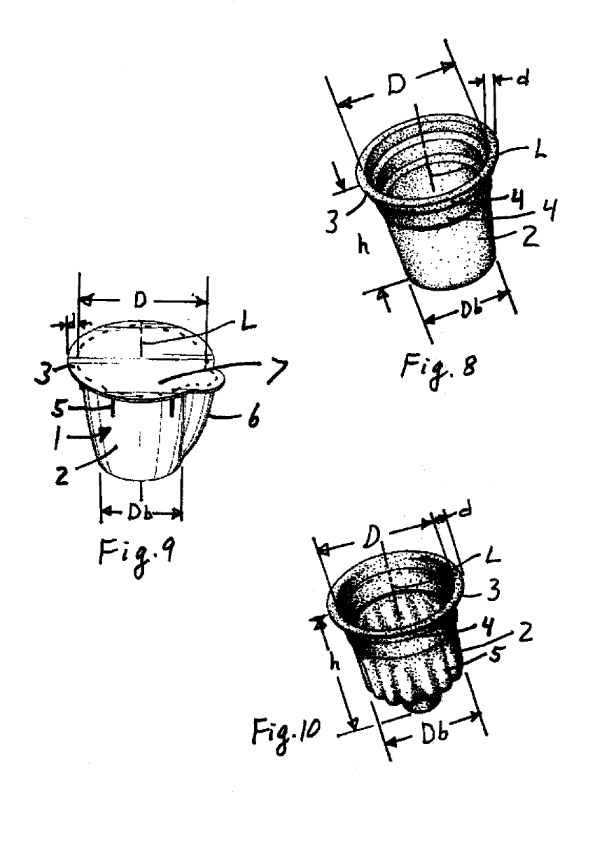

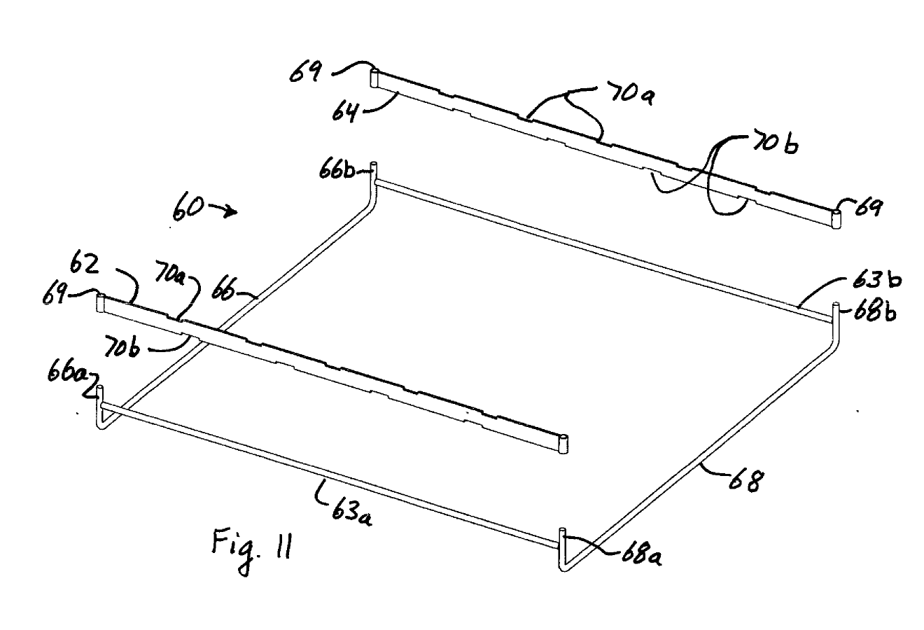

The tray 10 and housing 12 are both preferably rectangular in shape with the width much larger than the height of the rectangle, but the proportions may vary. The tray 10 has a front 14 and back 16 joined by opposing sides 18, 20 and a bottom 22. The bottom 22 may have stiffening indentations or protrusions 23. The top of the tray 10 is preferably open but may be removably covered. The indentations or protrusions 23 are localized displacements of the bottom 22 to provide a stiffening rib or boss to the bottom 22. Displacements about one inch (25 mm) wide and about ¼ inch (2 mm) deep are believed suitable, with the indentations extending the length or width of the bottom 22, or close thereto. Narrower indentations or protrusions 23a of about ½ inch (13 mm) deep may also be provided, with FIGS. 1 and 7 showing one narrow, central indentation 23a at the middle of the bottom 22 with two indentations 23 on each side of the center indentation 23a.

Various constructions may be used to form the tray 10. In the depicted tray 10 a U-shaped frame 24 forms the bottom and corner posts at the front and back of the tray with a top member 25 joining the corner posts to form a rectangular front and back frame to which is fastened a sheet of material 26. The frame 24 is preferably of rectangular cross-section with the largest dimension parallel to the planes of the tray bottom and sides. The top frame member 25 is also preferably of the same rectangular cross-section but orientated in the plane of the front and back sides, and thus perpendicular to the bottom 22. The front 14 of the tray may have a handle to grab and manipulate the tray for opening and closing. Advantageously the top frame member 25 extends downward toward bottom 22 to form an opening or handle 28 in the front 14 to allow a user's finger to pull on the front 14 to open the tray 10 by removing it from housing 12 while pushing on the front 14 can insert the tray into the housing.

The sides 18, 20 preferably, but optionally, have a side frame 30 formed by top and bottom side frame members 30, 32, respectively. The top side frame member 30 preferably connects to and extends between the corners of the front and back frames 24, preferably at the top, and preferably along the side of those corner members. The top side frame member 30 is preferably rectangular in cross-section and of the same dimension as the front and back frames 24. Thus, the top side frame member 30 and the upright, vertically extending corners of the front and rear frames 24 are in substantially the same plane. The bottom side frame member 32 is in an orthogonal plane parallel to the bottom 22 and extends between the bottoms of the front and back frames 24. The side frames preferably encircle or enclose the periphery of the sides 18, 20, and are fastened to the sheet of material 26. The material 26 is preferably a sheet of material and may be a continuous, solid sheet or an open, mesh material, or other construction. A sheet of metal mesh or wire mesh is preferred.

The sheet of mesh material 26 preferably extends along and forms the bottom 22 of the tray and is bent upward along the front to form front 14 and bent upwards along the back of the tray to form the back 16. The sides 18, 20 could be similarly formed or separate sheets of material could be cut from a sheet of material 26 and separately fastened to the side frames. Alternatively, the wire mesh may extend in one piece across the bottom 22 and opposing sides 18, 20 with the front and back 14, 16 being fastened to separate sheets of material 26.

The various frames and frame members may be fastened together and fastened to the sheet of material 26 various ways, including spot welding, friction bonding, melting, adhesives, mechanical connections such as snap locks or interference fits or other ways known in the art or developed hereafter. The precise connection is not believed critical, but spot welding metal frames of the same rectangular cross-section together to form the frames is believed preferable, and spot welding the frames to a metal mesh sheet of material 26 is believed preferable.

The tray 10 is sized to fit into an opening in the front of the housing 12. The housing 12 is rectangular in shape and preferably has a corresponding shape as the tray 10, but slightly larger than the tray. The housing has a front 44, along with back 46, sides 48, 50 corresponding to sides 18, 20 of tray 10. The housing 12 also has a top wall 52 opposite bottom which is preferably open. The housing is preferably formed by an open, rectangular framework with a sheet of material on the top wall 52 of the frame. The housing framework is preferably formed of rods, with circular cross-sections preferred for the rods. Thus, there is a frame around the rectangular side 48, a frame around the rectangular side 50, a frame around the rectangular back 46, and a frame around the rectangular front 44. The front 44 forms an opening into which the tray 10 is slidably inserted, with the sides 48, 50 being long enough to allow the tray 10 to be inserted into the housing, and the front and back 44, 46 being wide enough to accommodate the width of the tray 10. Preferably the housing 12 is only slightly larger than the tray 10 by enough clearance that the tray 10 can be easily manually inserted into and removed from the housing 12 through opening in the front of the housing.

Along each bottom side of the opening in the front of the housing and extending along the junction of the sides 48, 50 and the bottom of the housing are located slides 54. The slides 54 extend between the front and back of the housing. The slides 54 have an L-shaped cross-section with one generally horizontal leg of the L extending along the bottom 42 and the other generally vertical leg of the L along one of the sides 48, 50. The slides 54 extend from the front 44 to the back 46 of the housing 12. The legs of the slides 54 are preferably the same as or slightly longer than the width of the longest side of the rectangular cross-section of side frames 24. Thus, the side frames 24 may form runners that slide along the length of the slides 54 as the tray 10 is inserted into and removed from the housing 12. Advantageously, the bottom member of the side frame 24 is an exterior frame member with the bottom 22 of the tray fastened to a top of that bottom member, with the exterior frame member 24 abutting and sliding along slide 54 as the tray 10 moves in and out of the housing 12.

In use, the tray 10 is pulled partially out of or entirely out of the housing 12. Coffee pods may be placed inside the tray 10 with dividers 35 in the tray 10 positioning the coffee pods. The tray 10 is pushed back into the housing 12 after a coffee pod is selected. The top wall 52 of the housing is preferably strong enough that a coffee maker may rest on the top 52.

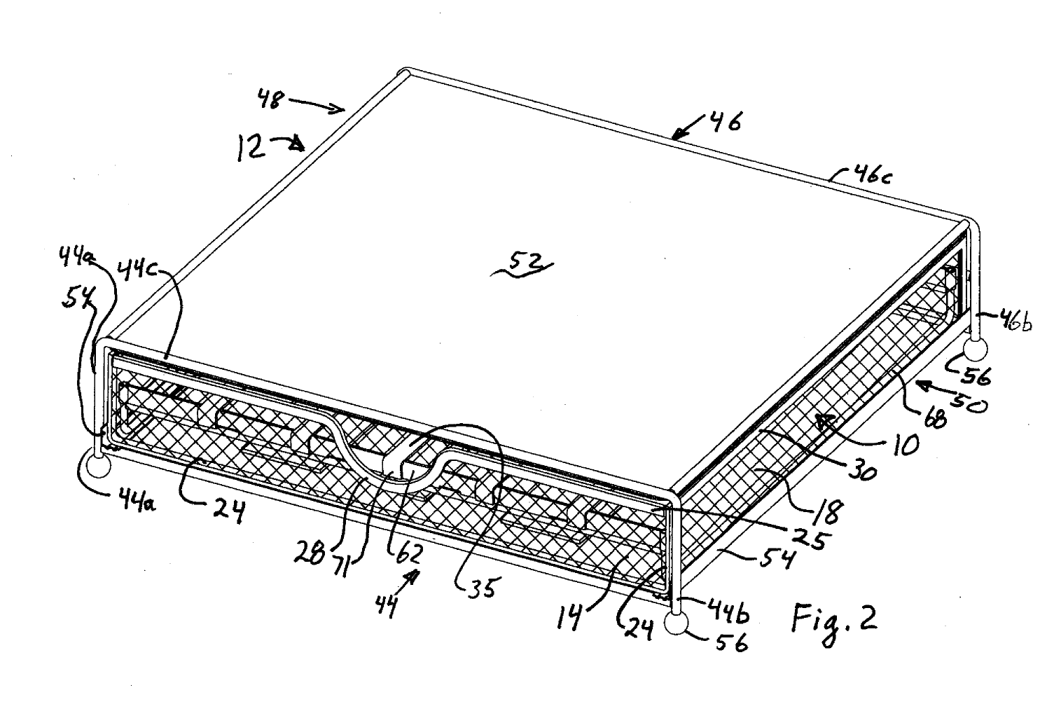

Referring to FIGS. 2, 3 and 5 the front frame 44 has generally vertical side posts 44a, 44b joined by generally horizontal top and bottom members 44c, and 44d. Likewise, rear frame 46 has generally vertical side posts 46a, 46b joined by generally horizontal top and bottom members 46c, 46d. The frames 44, 46 are preferably formed of rods having circular cross section with the sides posts 44a, 44b, 46a, 46b and top members 44c, 46c being one continuous, integrally formed member bent into shape and ending at feet 46. Bottom or lower members 44d, 46d are spot welded to the posts 44a, 44b, 46a, 46b between which the lower members extend. Other constructions of the frames 44, 46 may be used. Preferably, a back stop member 53 extends between rear corner posts 46a, 46b at a location selected to abut the back of the tray 10 and prevent the tray from sliding out the back of the housing. Other forms of motion stops could be provided, including projections extending from rear corner posts 46a, 46b, or an upturned flange on the slider 54.

Referring to FIGS. 2, 3 and 5, the ends of the distal slides 54 that fasten to the front and rear frames 44, 46, respectively, are corrugated or indented to form a wavy portion at the distal ends of the slides 54. The indentations or waves begin at or very near the distal end of the slides 54 and extend along the length of the slide for a short distance of about ⅛ to one inch, but may extend further from the distal ends. The indentations form longitudinal indentations, with from one to three indentations being preferred. The bottom of the indentations or waves are preferably thermally bonded (e.g., spot welded) to the bottom members 44d, 46d of the wire frames 44, 46 to which the slides 54 fasten, but other fastening mechanisms can be used, such as adhesives or mechanical connections. The longitudinal indentations or wavy portions help strengthen the connection with the lower frame members 44d, 46d to which the slides 54 fasten and help strengthen the bottom portion of the slides 54 at the distal ends of the slides where they connect to the lower frame members 44d, 46d of the front and rear sides of the tray. The slides 54 advantageously extend between and fasten to the top of the lower frame members 44d, 46d.

In further variations, the housing 12 and tray 10 may be repeated and either stacked on top of each other to form separate, stacked structures. Or alternatively, the housing sides 48, 50 may be extended to form a single piece side that accommodates a plurality of openings 40 with at least the slides 54 joining the front and back 46, 48 of the housing for each tray. Alternatively, the sides 54 may be joined to the sides 48, 50 of the housing, or joined to any combination of the sides, front or back of the housing. Housings 12 with multiple trays are depicted in application Ser. No. 29/431,043 titled Slidable Wire Tray & Container filed Aug. 31, 2012, the complete contents of which are incorporated herein by reference.

Advantageously a foot 56 is located at each bottom corner of the housing 12. Each foot 56 may be separately fastened to the bottom corner by various means such as adhesives, threaded fasteners, thermal bonding such as spot welding, etc. Advantageously the foot 56 is formed on a slightly extending end of a portion of the rods forming the corner posts 44a, 44b, 46a, 46b of the front 44 or back 46 of the housing, but could be formed by extending the rods forming the sides 48, 50 of the housing. FIGS. 1-3 show the foot 56 being formed by a downwardly extending rod forming the front and back 44, 46 of the housing, with each foot 56 having a recess to receive the downwardly extending rod.

Referring to FIGS. 1-2, the coffee pods are advantageously held within the tray 10 by dividers 35 fastened to front and back support rails 62, 64 on a support frame in order to form a coffee pod holder 60. The dividers 35 are spaced apart a distance sufficient to allow a plurality of coffee pods to be inserted between the dividers 35 when aligned in a row and the pods may rest on the bottom 22 of the tray 10. Advantageously, the indentations/protrusions 23 are located between the dividers 35 and extend along the length of the rows formed by the dividers.

Referring to FIGS. 1 and 11-13, the holder 60 can be reconfigured to hold differing coffee pods and to form different numbers of rows for holding coffee pods. These figures depict five dividers 35 forming six rows in the tray 10. The holder 60 can be formed various ways, but is depicted as having a frame formed by two, U-shaped side frames 66, 68 with the short legs of the U 66a, 66b, 68a, 68b preferably oriented upward, away from bottom 22 during use. Two connecting members 63a, 63b extend between the side frames 61a, 61b to form a generally rectangular shaped support sized to fit inside the tray 10 so the short, upstanding legs of the U-shaped side frames 61a, 61b are at or near the corners of the tray 10. The connecting members 63a, 63b preferably fasten to the upstanding legs of the U-shaped side frames 61a, 61b, at about the middle of the length of those legs. That leaves the four ends 64a, 64b, 64c, 64 of the U-shaped side frames 61 orientated upwards.

The ends of support rail 62 removably connect to the ends 66a, 68a and the ends of support rail 64 removably connect to ends 66b, 68b. The removable connection can be achieved various ways but preferably each of the ends of support rails 62, 64 have a cylindrical hole 69 sized to fit over ends 66a, 66b, 68a, 68b. The support rails 62, 64 are preferably rectangular in cross section with the long section perpendicular to bottom 22 and parallel to ends 66a, 66b, 68a, 68b, with the cylindrical hole 69 aligned with the ends 66a, 68a, etc. Thus, the rails 62, 64 can be removably fastened to the ends 66a, 66b, 68a, 68b by fitting the ends into the holes 69. If the ends 66a, 66b, 68a, 68d have a different cross-sectional shape than circular, the hole 69 is preferably changed to match and to fit closely over the ends 66a, 66b, 68a, 68b. Advantageously, the end of the support rails 62, 64 hits the adjacent connecting member 63a or 63b adjacent the end 66a, 66b, 68a, 68b to position the upper edges of the rails.

In use, the support rails 62, 64 extend along and are optionally fastened to a portion of the tray 10 or the frame members 24, 25, 30, 32 of the tray 10. But because the holder 60 is self-supporting it may also be set into the tray 10 and rest on the bottom 22 of the tray. The dividers 35 are removably fastened to the support rails 62, 64. Preferably, but optionally, the opposing ends 71 of each divider 35 are curved or bent to form a right angle bend that hooks over one of the support rails 62, 64. Optionally, the ends 71 could have a shaped recess configured to snap fit onto the edge of the support rail 62, 64 as shown in FIG. 18a. The snap lock connect is especially advantageous if the mating top of the support rail 62, 64 has a circular cross-section or if the rail itself has a circular cross section with the recesses 70 formed by bends in the rails.

Moreover, each opposing edge of the support rails 62, 64 has a series of recesses or notches 70. The notches 70 are preferably shaped to receive an abutting portion of the divider 35 within in the notch and preferably sized relative to the divider to restrain the edges of the divider from moving laterally along the length of the support rails 62, 64. Since the dividers are preferably flat, elongated members with a rectangular cross-sectional shape about ⅜ to ½ inch wide (8-13 mm), the notches are flat bottomed recesses in the edges of the rails 62, 64.

The notches 70 are spaced apart a predetermined distance to form rows within which the coffee pods are placed. The spacing between notches 70a on a first edge 72a of dividers 62, 64 is selected so the dividers receive smaller dimensioned coffee pods with five dividers 35 in five notches 70a forming six rows of coffee pods in the tray 10. The support rails 62, 64 have a second opposing edge 72b with four notches 70b. The four notches 70b are spaced apart a distance so the dividers 35 receive large dimensioned coffee pods such that four dividers form five rows of coffee pods during use as shown in FIGS. 14-16. The rows formed by adjacent dividers 35 are large enough to keep a plurality of coffee pods aligned in the respective rows, and preferably are close enough to the size of the coffee pods resting in the rows that the lips or flange 3 (FIG. 9) of the coffee pod will catch on adjacent dividers to keep the coffee pods from tipping completely over within the row in which the coffee pod is placed. Advantageously, the spacing between the rows formed by adjacent dividers 35 are about the diameter D of a coffee pod measured at the height of the divider when the coffee pods are resting on bottom 22 during use.

In use, the coffee pod holder 60 is configured for use with larger coffee pods by removing the support rails 62, 64 from the ends 66a, 66b, 68a, 68b and orienting the rails so the edge of the support rail with the desired number of recesses or notches 70 is at the top or facing upward, away from bottom 22. Four notches 70b and four dividers form five rows sized receive the Vue® container. It is usually easier to do this with the holder 60 removed from the tray 10, but removal is not believed necessary.

FIGS. 11-13 show five dividers 35 extending between the support rails 62, 64 with each divider 35 fitting into corresponding notches 72 in the rails to form a series of parallel dividers defining plural rows sized to receive coffee pods. But the number of dividers could vary. It is believed more efficient to form the holder 60 outside the tray 10 and then place the holder to the tray 10 and if desired to fasten it by various means, including spot welding, adhesives, hooks, snap locking projections, threaded fasteners, mechanical fasteners etc.

The holder 60 thus forms a generally U-shaped frame which may be lifted by the upper rails 62, 64. When the holder 60 is placed inside the tray 10, the bottom members 70a, 70b rest against the bottom 22 of the tray to support the rails a predetermined location above the bottom 22. The figures show five dividers 35 for K-cup coffee pods, or four dividers 35 for five rows of Vue® coffee pods. But the number of dividers 35 in the holder 60 may vary depending on the size of the tray 10 and the configuration of the holder 60 and its dividers 35.

Conceptually, the lateral edges of the dividers 35 are spaced apart a distance D₁ when the dividers are a first set of locations defined by notches 70a to receive coffee pods of a diameter greater than D₁. The lateral edges of the dividers 35 are spaced apart a distance D₂ when the dividers 35 are a second set of locations defined by notches 70b to receive coffee pods of a diameter greater than D₂. D₁ is different from D₂ and preferably less than D₂. The spacing between the dividers 35 is the same, including the spacing between the edge of the divider and the adjacent side of the tray 10 which spacing also forms a row along each side of the tray.

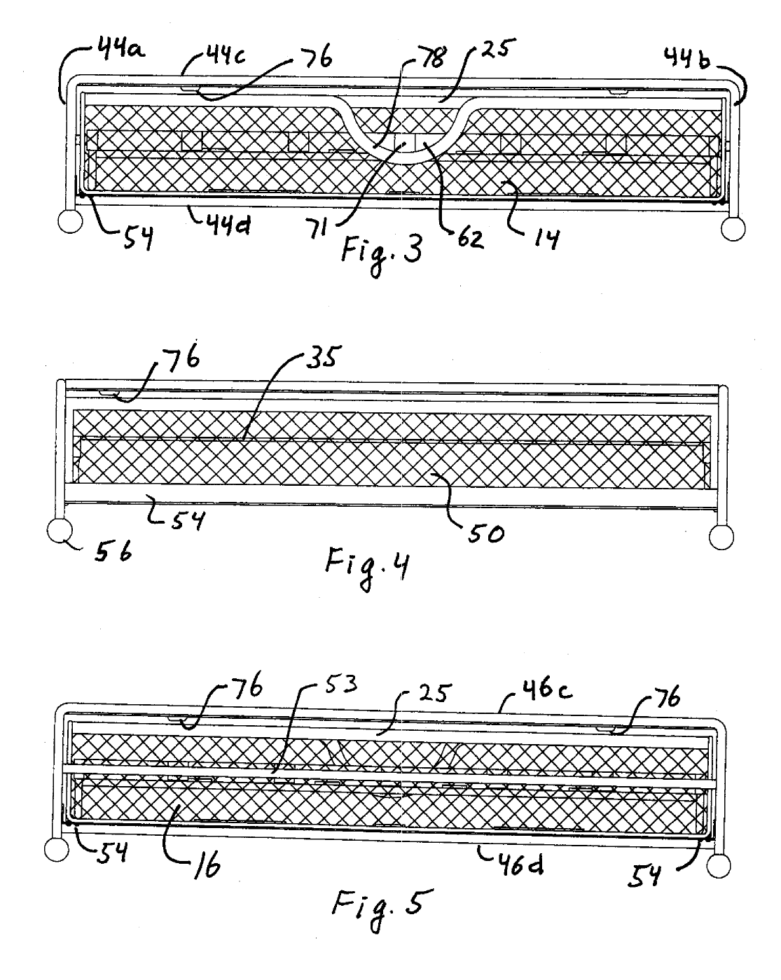

Referring to FIGS. 3-5, one or more recesses are formed in the top wall 52 of the housing 12. The recesses are depressed areas offset from the generally planar top wall 52 in a direction toward the location of the tray 10 within the housing during use. The recess in the top wall 52 forms a protrusion 76 extending toward the tray 10. A circular or rectangular recess is believed suitable, and may be formed by punching or deforming the top wall 52 in the downward direction as viewed in FIGS. 3-5.

As desired, the protrusion 76 may extend downward a distance sufficient to engage the topmost edge of the back 16 of tray 10 as the stray slides from the housing 12. The protrusion 76 thus forms a motion limit stop and extends downward a distance sufficient to abut the back 16 of tray 10 and thus limit the distance which a tray 10 may be withdrawn from the housing 12. The stop 76 is conceptually a protrusion on the housing 12 (including the frame forming the housing) that hits the tray 10 to limit relative motion between the tray and housing. The depicted stop 76 comprises a downward extending protrusion formed in the top 52, but it could include a rivet fastened to the bottom of recess forming the protrusion if the deformation of the top 52 was limited. The 76 is located so that the tray 10 can be tilted so the back 16 of the tray can pass below the stop 76 in order to insert the tray into the housing 12 and then orientate the tray 10 horizontally to complete the insertion into the housing. When the tray is removed horizontally the stop 76 hits the back side 16 of the tray to limit relative motion of the tray 10 and housing 12. Advantageously, a covering such as a non-slip polymer or rubber may be placed over the top 52 to hide the recess forming the stop 76 from view. Advantageously, there are two protrusions or stops 76, one adjacent each opposing side of the top wall 52 and adjacent the sides 18, 20 of the tray 10.

In the depicted embodiments the dividers 35 have a width that is larger than their depth in the orthogonal direction. But the dividers may have various shapes, including circular or rectangular or triangular cross-sectional shapes. As used herein, a rectangular shape includes a square. Likewise, even dividers 35 with rectangular cross-sections can be orientated so the wider side of the cross-section is perpendicular to the tray bottom 22 during use, rather than generally parallel to the bottom as shown in FIG. 1.

The notches are shown as rectangular in shape with flat bottoms. They could be various configurations. Likewise, a pair of protrusions formed by spot welds or upsetting the top surface of a rod could form a notch between them. Thus, the term “notch” is not to be limited to recesses extending below the general surface of the support rail and extending into the material forming the support rail. The dividers 35 are shown as flat, elongated members but could have various shapes, including cross-sectional shapes such as a T shape shown in FIGS. 17a, 17b or an I shape shown in FIG. 18a, 18b. FIG. 17a shows a bent or curved end 71 while FIG. 18a shows a snap lock feature on end 71.

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

Although these inventions have been disclosed in the context of certain preferred embodiments and examples, it will be understood by those skilled in the art that the present inventions extend beyond the specifically disclosed embodiments to other alternative embodiments and/or uses of the inventions and obvious, modifications and equivalents thereof. In addition, while several variations of the inventions have been shown and described in detail, other modifications, which are within the scope of these inventions, will be readily apparent to those of skill in the art based upon this disclosure. It is also contemplated that various combination or sub-combinations of the specific features and aspects of the embodiments may be made and still fall within the scope of the inventions. It should be understood that various features and aspects of the disclosed embodiments can be combined with or substituted for one another in order to form varying modes of the disclosed inventions. Thus, it is intended that the scope of at least some of the present inventions herein disclosed should not be limited by the particular disclosed embodiments described above.

What is claimed is:

1. A coffee pod holder for a rectangular tray, the holder having dividers defining rows for aligning a plurality of first or second coffee pods having first and second sizes which are different, the holder comprising:
a frame having four corner posts at each corner of a rectangle sized to fit within a tray;
first and second support rails each removably connected to a different two of the corner posts and generally parallel to each other, each support rail having opposing first and second edges with a first set of notches in the first edge and a second set of notches in the second edge, the first set of notches being located at corresponding first locations along a length of each rail and the second set of notches being located at corresponding second locations along a length of each rail, the first set of notches being different in number than the second set of notches, the rails having a first position in which both of the first edges are located above the second edges and having a second position in which both of the second edges are located above the first edges;
a plurality of dividers extending between the support rails with each divider at a different set of corresponding locations of the first set of notches so the dividers are parallel to each other, the dividers having a cross-sectional shape that fits into one of the first set of notches when the support rails are in the first position, the cross-sectional shape of the divider cooperating with the shape of that notch to restrain lateral motion of the divider along a length of the support rail in which the notch is located, the dividers having opposing sides located a distance apart to define rows between the dividers sized to receive and align a plurality of first coffee pods in the rows during use.

2. The coffee pod holder of claim 1, wherein both support rails may be removed and positioned with the second set of notches orientated in the second position so a plurality of dividers may rest in corresponding notches of the second set of notches to define a different number of rows for holding a plurality of the second coffee pods during use

3. The coffee pod holder of claim 1, wherein a plurality of the corner posts have a position stop located a distance from the distal end of the corner post on which the position stop is located, the position stop restraining movement of one of the support rails along the length of the post on which the position stop is located.

4. The coffee pod holder of claim 2 wherein each corner post has a position stop located so the first edge of the support rails are in substantially the same plane.

5. The coffee pod holder of claim 2, wherein the support rails have ends with holes therethrough, with each corner post extending into a different one of the holes to connect the support rails to the frame.

6. The coffee pod holder of claim 5, where the holes are cylindrical and sized to snugly receive the corner posts.

7. The coffee pod holder of claim 1, wherein the four corner posts form legs of two inverted, U-shaped end frames which are generally parallel to each other, and further comprising first and second connecting members each extending between and connecting to different corner posts each on a different end frames, the connecting members being parallel to each other and connecting to their respective corner posts a predetermined distance from the distal end of each corner post to restrain movement of the support rail along a length of the end post.

8. The coffee pod holder of claim 1, wherein the number of notches in the first set is greater than the number of notches in the second set.

9. The coffee pod holder of claim 1, wherein the first side of the support rail has five notches, each of which supports a divider.

10. The coffee pod holder of claim 1, wherein the second side of the support rail has four notches.

11. The coffee pod holder of claim 1, wherein the first set of notches are each spaced apart the same predetermined distance which is selected so that when two of the dividers are placed in corresponding notches in the first and second support rails, the adjacent edges of the two dividers are spaced apart a distance about that of the largest diameter of a K-cup coffee pod.

12. The coffee pod holder of claim 10, wherein the second set of notches are each spaced apart the same predetermined distance which is selected so that when two of the dividers are placed in corresponding notches in the first and second support rails, the adjacent edges of the two dividers are spaced apart a distance about that of the largest diameter of a Vue-cup coffee pod.

13. The coffee pod holder of claim 1, wherein the second set of notches are each spaced apart the same predetermined distance which is selected so that when two of the dividers are placed in corresponding notches in the first and second support rails, the adjacent edges of the two dividers are spaced apart a distance about that of the largest diameter of a Vue-cup coffee pod.

14. The coffee pod holder of claim 1, wherein the holder is placed in a tray larger than the holder with the holder connected to the tray to restrain movement of the holder relative to the tray, the holder positioned in the tray so that the dividers on opposing sides of the holder are spaced apart from adjacent sides of the tray a distance sufficient to define a row between the sides of the tray and the adjacent dividers with the row sized to hold coffee pods during use.

15. The coffee pod holder of claim 1, wherein the tray is inserted into an opening of a housing sized to slidably receive the tray, the opening in the housing having the same shape as the tray but slightly larger.

16. The coffee pod holder of claim 1, wherein at least one of the ends of a plurality of the dividers is configured to form a snap-lock connection with the support rail.

17. The coffee pod holder of claim 1, wherein a plurality of the dividers have ends curved to hook over each of the support rails and restrain movement of the divider along a length of the divider.

18. A coffee pod holder for a rectangular tray that is slidably inserted into a housing, the holder having dividers defining rows for holding a plurality of coffee pods in the rows having first and second sizes which are different, the holder comprising:
a divider support frame having four corner posts at each corner of a rectangle sized to fit within the tray, the divider support frame being fastened to the tray during use;
first and second support rails that are generally parallel to each other, each support rail having opposing first and second edges with a first set of equally spaced notches in the first edge and a second set of equally spaced notches in the second edge, the first set of notches being different in number than the second set of notches, the support rails having a first position in which both of the first edges are above the second edges and having a second position in which both of the second edges are above the first edges, the support rails being removably connected to two of the corner posts in the first and second position;
a plurality of dividers extending between notches of the first set of notches so the dividers are parallel to each other, the dividers fitting into one of the first set of notches and cooperating with that notch to limit lateral motion of the divider along a length of the support rail in which the notch is located, the dividers having two opposing sides located a distance apart to define rows between the dividers for receiving a plurality of first coffee pods in the rows during use when the support rails are in the first position, the dividers being parallel to each other and perpendicular to the support rails, a plurality of the dividers extending between notches of the second set of notches and parallel to each other when the support rails are in the second position, the dividers fitting into one of the second set of notches and cooperating with that notch to limit lateral motion of the divider along a length of the support rail in which the notch is located, the dividers having two opposing sides located a distance apart to define rows between the dividers for receiving a plurality of second coffee pods in the rows during use when the support rails are in the second position.

19. The coffee pod holder of claim 1, wherein the notches are rectangular and longer along the length of the support rail than they are measured along an axis directed toward the opposing edge of the divider.

20. The coffee pod holder of claim 18 wherein a plurality of the corner posts have a position stop located a distance from the distal end of the corner post on which the position stop is located, the position stop limiting movement of one of the support rails along the length of the post on which the position stop is located.

21. The coffee pod holder of claim 18, wherein the four corner posts form legs of two inverted, U-shaped end frames which are generally parallel to each other, and further comprising first and second connecting members each extending between and connecting to different corner posts each on a different end frames, the connecting members being parallel to each other and connecting to each corner post a predetermined distance from the distal end of each corner post to restrain movement of the support rail along a length of the end post.
